(19) United States
(12) Patent Application Publication
(10) Pub. No.: US 2025/0054131 A1
(43) Pub. Date: Feb. 13, 2025

(54) INFORMATION PROCESSING DEVICE, INFORMATION PROCESSING SYSTEM, INFORMATION PROCESSING METHOD, AND RECORDING MEDIUM

(71) Applicant: Mitsubishi Electric Corporation, Tokyo (JP)

(72) Inventor: Tomohiro IKEDA, Nagoya-shi, Aichi (JP)

(73) Assignee: Mitsubishi Electric Corporation, Tokyo (JP)

(21) Appl. No.: 18/723,478

(22) PCT Filed: May 24, 2022
(86) PCT No.: PCT/JP2022/021268

§ 371 Date: Jun. 24, 2024

(51) Int. Cl. G06T 7/00

(52) U.S. Cl. CPC G06T 7/0008; G06T 2207/20081; G06T 2207/20084; G06T 2207/30108

(57) ABSTRACT

An information processing device includes an inspection processor to inspect quality of a target product, using inspection model data for inspection of the quality, generated by learning first target data based on first products by inspection learning means, and a conversion processor to convert target data based on the target product into converted target data similar to first target data, using conversion model data for conversion of second target data into the converted target data, generated by learning second target data based on second products and the first target data by conversion learning means. The inspection processor inspects the target data based on the target product when external information indicates that the target product is a first product, and inspects the converted target data obtained by conversion by the conversion processor from the target data when the information indicates that the target product is a second product.

### TECHNICAL FIELD

The present disclosure relates to an information processing device, an information processing system, an information processing method, and a program.

### BACKGROUND ART

In recent years, automation of inspection processes has been developed in the manufacturing industry. For example, Patent Literature 1 discloses a technique of generating a reconstructed image in accordance with feature quantities extracted from a target image to be inspected, and determining abnormality on the basis of information on the difference between the reconstructed image and the target image. The reconstructed image is generated using a neural network that has learned a model for reconstructing a normal image in accordance with feature quantities extracted from a normal image among the images captured in a production line.

### CITATION LIST

### Patent Literature

Patent Literature 1: Unexamined Japanese Patent Application Publication No. 2018-005773

### SUMMARY OF INVENTION

### Technical Problem

The technique disclosed in Patent Literature 1 is applied to abnormal determination of target images captured in a single production line. The actual factories, however, include multiple production lines for manufacturing products of the same type. If one production line is able to use a neural network for abnormal determination that has learned normal images captured in another production line, this improvement can eliminate the tasks of pretreatments, such as labeling and annotation of collected images and the tasks of relearning the neural network. The images captured in the other production line, however, inevitably differ from the images captured in the one production line, because of different imaging conditions between the production lines, including the orientation of a camera, background, and lightening. That is, the neural network that has learned images captured in the other production line cannot be directly applied to the abnormal determination in the one production line.

An objective of the present disclosure, which has been accomplished to solve the above problems, is to provide an information processing device, an information processing system, an information processing method, and a program that can inspect a piece of target data using an inspection model generated by learning, by machine learning means, pieces of target data collected in another environment.

### Solution to Problem

In order to achieve the above objective, an information processing device according to the present disclosure includes: an inspection processor to inspect quality of an inspection target product based on inspection model data for inspection of the quality of the inspection target product, the inspection model data being generated by learning first inspection target data by inspection learning means, the first inspection target data being data based on a first product; and a conversion processor to convert inspection target data that is data based on the inspection target product into converted inspection target data similar to the first inspection target data based on conversion model data for conversion of the second inspection target data into the converted inspection target data, the conversion model data being generated by learning second inspection target data and the first inspection target data by conversion learning means, the second inspection target data being data based on a second product. When the inspection processor determines in accordance with external information that the inspection target product is a first product, the inspection processor directly inspects the piece of inspection target data that is data based on the inspection target product. When the inspection processor determines in accordance with the external information that the inspection target product is a second product, the inspection processor inspects the converted inspection target data obtained by conversion by the conversion processor from the inspection target data.

### Advantageous Effects of Invention

The information processing device according to the present disclosure can convert second product image data on an image of the second product into image data similar to first product image data on an image of the first product, apply the converted image data to a neural network that has learned the first product image data, and thus evaluate the quality of the second product. The information processing device can thus inspect a piece of inspection target data even when using an inspection model generated by learning, by machine learning means, inspection target data collected in another environment.

### BRIEF DESCRIPTION OF DRAWINGS

FIG. 1 illustrates a configuration of an information processing system according to Embodiment 1 of the present disclosure;

FIG. 2 illustrates a configuration of a controller of an information processing device according to Embodiment 1 of the present disclosure:

FIG. 3 illustrates an exemplary hardware configuration of the information processing device according to Embodiment 1 of the present disclosure:

FIG. 4A is a schematic diagram illustrating a part of an inspection neural network according to Embodiment 1 of the present disclosure:

FIG. 4B is a schematic diagram illustrating the rest part of the inspection neural network other than the part illustrated in FIG. 4A:

FIG. 5A is a schematic diagram illustrating a part of a conversion neural network according to Embodiment 1 of the present disclosure:

FIG. 5B is a schematic diagram illustrating the rest part of the conversion neural network other than the part illustrated in FIG. 5A:

FIG. 6 is a flowchart illustrating a process of generating a piece of inspection model data according to Embodiment 1 of the present disclosure;

FIG. 7 is a flowchart illustrating a process of generating a piece of conversion model data according to Embodiment 1 of the present disclosure;

FIG. 8 is a flowchart illustrating an inspection process according to Embodiment 1 of the present disclosure:

FIG. 9 illustrates a configuration of a controller of an information processing device according to Embodiment 2 of the present disclosure; and

FIG. 10 is a flowchart illustrating a combination process according to Embodiment 2 of the present disclosure.

### DESCRIPTION OF EMBODIMENTS

### Embodiment 1

The following describes an information processing device 3 according to Embodiment 1 of the present disclosure and an information processing system 100 including the information processing device 3, with reference to the accompanying drawings. The components identical or corresponding to each other are provided with the same reference symbol.

The information processing device 3 converts a piece of second product image data 221 on an image of a second product 21 captured in a second production line 2 into a piece of image data similar to a piece of first product image data 121 on an image of a first product 11 captured in a first production line 1, using a conversion neural network 402. The information processing device 3 then inputs a piece of converted image data 231 into an inspection neural network 401 that has learned pieces of first product image data 121, and determines the quality of the product. The information processing device 3 can thus accurately evaluate the quality of the product from the piece of second product image data 221 using the inspection neural network 401 that has learned pieces of data, thereby eliminating the tasks of relearning a neural network for collected images. The information processing device 3 is included in the information processing system 100.

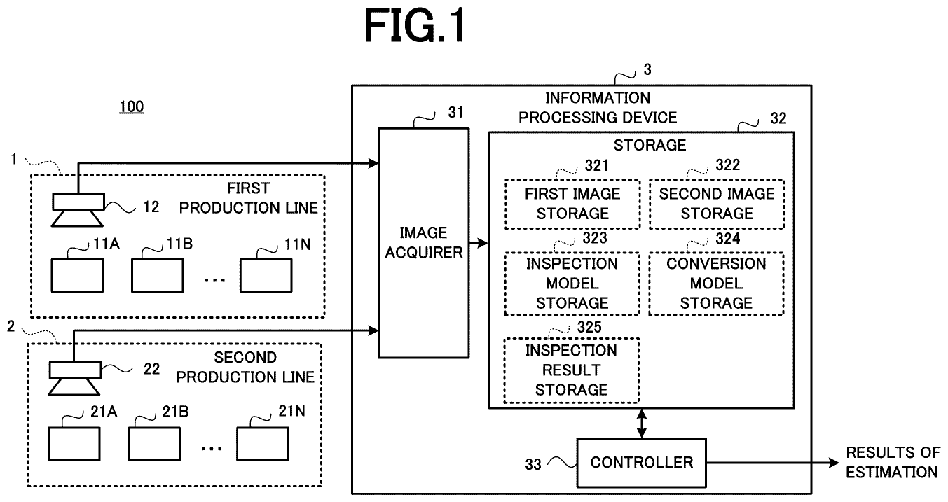

FIG. 1 illustrates a configuration of the information processing system 100. The information processing system 100 includes the first production line 1 that manufactures first products 11A, 11B, . . . and 11N, the second production line 2 that manufactures second products 21A, 21B, . . . and 21N, and the information processing device 3 that evaluates the quality of the products from captured images. The first products 11A, 11B, . . . and 11N are hereinafter collectively referred to as “first products 11”. The second products 21A, 21B, . . . and 21N are hereinafter collectively referred to as “second products 21”. The first products 11 and the second products 21 are completed products or components to be included in the products, examples of which include vehicles, semiconductor components, and works for processing.

The first production line 1 manufactures the first products 11, which are manufacturing targets. The first production line 1 includes a first imager 12 that captures images of the first products 11 being transported in the line and generates pieces of first product image data 121. The second production line 2 manufactures the second products 21, which are manufacturing targets. The second production line 2 includes a second imager 22 that captures images of the second products 21 being transported in the line and generates pieces of second product image data 221.

The information processing device 3 includes an image acquirer 31 that acquires the pieces of first product image data 121 and the pieces of second product image data 221, a storage 32 that stores various types of data and programs, and a controller 33 that executes various processes. The image acquirer 31 acquires the pieces of first product image data 121 on images of the first products 11 from the first imager 12 of the first production line 1. The image acquirer 31 also acquires the pieces of second product image data 221 on images of the second products 21 from the second imager 22 of the second production line 2. The piece of first product image data 121 is an example of a piece of first inspection target data based on a first product in the claims. The piece of second product image data 221 is an example of a piece of second inspection target data based on a second product in the claims.

The storage 32 includes a first image storage 321 that stores the pieces of first product image data 121, a second image storage 322 that stores the pieces of second product image data 221, an inspection model storage 323 that stores at least one piece of inspection model data 411 described below, a conversion model storage 324 that stores at least one piece of conversion model data 421 described below, and an inspection result storage 325 that stores results of inspection. The first image storage 321 stores the pieces of first product image data 121 acquired by the image acquirer 31 from the first imager 12. The second image storage 322 stores the pieces of second product image data 221 acquired by the image acquirer 31 from the second imager 22.

The inspection model storage 323 stores the piece of inspection model data 411 to be applied to the inspection neural network 401 described below. The conversion model storage 324 stores the piece of conversion model data 421 to be applied to the conversion neural network 402 described below. The inspection result storage 325 stores results of inspection of the pieces of first product image data 121 and the pieces of second product image data 221 using the inspection neural network 401 described below.

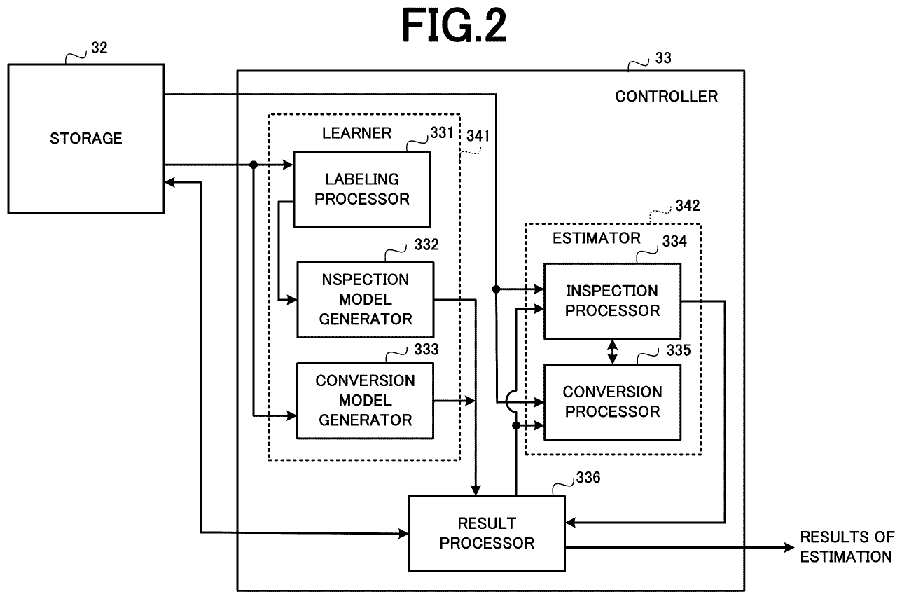

As illustrated in FIG. 2, the controller 33 includes a labeling processor 331 that labels a piece of image data as a pass or a failure, an inspection model generator 332 that generates a piece of inspection model data 411, a conversion model generator 333 that generates a piece of conversion model data 421, an inspection processor 334 that inspects the piece of first product image data 121 and the piece of second product image data 221, a conversion processor 335 that converts the piece of second product image data 221, and a result processor 336 that processes results of inspection.

The labeling processor 331 labels the piece of first product image data 121 as a pass or a failure. For example, the labeling processor 331 determines a piece of first product image data 121 that satisfies predetermined conditions to be “normal” and labels the piece of image data as a “pass”, among the clustered pieces of first product image data 121. The labeling processor 331 determines a piece of first product image data 121 that fails to satisfy the predetermined conditions to be “abnormal” and labels the piece of image data as a “failure”.

The inspection model generator 332 learns the inspection neural network 401 based on the input pieces of first product image data 121 labeled by the labeling processor 331, and generates a piece of inspection model data 411 in accordance with the results of learning. The conversion model generator 333 learns the conversion neural network 402 based on the input pieces of first product image data 121 and pieces of second product image data 221, and generates a piece of conversion model data 421 in accordance with the results of learning. The labeling processor 331, the inspection model generator 332, and the conversion model generator 333 are hereinafter collectively referred to as “learner 341”. The inspection neural network 401 is an example of inspection learning means in the claims. The conversion neural network 402 is an example of conversion learning means in the claims.

The piece of inspection model data 411 and the piece of conversion model data 421 generated by the learner 341 are output to the result processor 336. The result processor 336 causes the piece of inspection model data 411 and the piece of conversion model data 421 to be respectively stored into the inspection model storage 323 and the conversion model storage 324 of the storage 32 illustrated in FIG. 1.

The inspection processor 334 inspects the piece of first product image data 121 and the piece of second product image data 221, using the inspection neural network 401. The inspection neural network 401 used in the inspection processor 334 is set by applying the piece of inspection model data 411 thereto, which is acquired from the inspection model storage 323 of the storage 32 illustrated in FIG. 1 via the result processor 336. The inspection processor 334 outputs the results of inspection to the result processor 336.

The conversion processor 335 converts the piece of second product image data 221 into a piece of converted image data 231 similar to the piece of first product image data 121, using the conversion neural network 402. The conversion neural network 402 used in the conversion processor 335 is set by applying the piece of conversion model data 421 thereto, which is acquired from the conversion model storage 324 of the storage 32 illustrated in FIG. 1 via the result processor 336. The conversion processor 335 outputs the piece of converted image data 231 to the inspection processor 334, and the inspection processor 334 then executes inspection on the basis of the received piece of converted image data 231. The piece of second product image data 221 can thus be inspected using the inspection neural network 401 that has learned the pieces of first product image data 121. The inspection processor 334 and the conversion processor 335 are hereinafter collectively referred to as “estimator 342”. The piece of converted image data 231 is an example of a piece of converted inspection target data in the claims.

The result processor 336 causes the results of inspection received from the inspection processor 334 to be stored into the inspection result storage 325 of the storage illustrated in FIG. 1. The result processor 336 also transmits the results of inspection, which is received from the inspection processor 334, to an external device, such as display for presenting information to the user, or server, outside the information processing device 3.

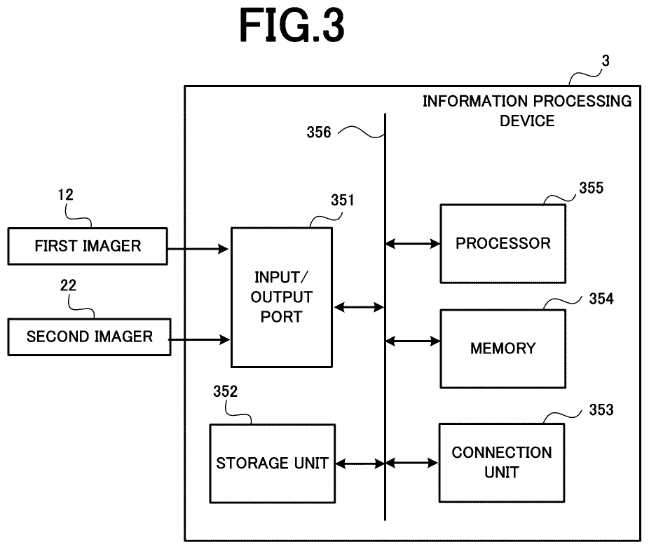

In Embodiment 1, the individual functions of the information processing device 3 illustrated in FIG. 1 and the individual functions of the controller 33 of the information processing device 3 are achieved by software. The software, that is, programs are executed by the hardware configuration of the information processing device 3, an example of which is illustrated in FIG. 3.

The information processing device 3 includes an input/output port 351 connected to the first imager 12 that captures images of the first products 11 and the second imager 22 that captures images of the second products 21, which are illustrated in FIG. 1, a storage unit 352 that stores various types of data and programs, a connection unit 353 for connection with external devices, a memory 354 for loading of various programs, and a processor 355 that executes various programs. The input/output port 351, the storage unit 352, the connection unit 353, the memory 354, and the processor 355 are connected to each other with data buses 356.

The input/output port 351 can be connected to various input/output devices, including the first imager 12 and the second imager 22 illustrated in FIG. 1. The input/output port 351 may include a terminal pursuant to any of various connection standards, such as universal serial bus (USB), serial, and parallel connections. The first imager 12 and the second imager 22 may be any of various cameras capable of capturing still or moving images and acquiring the captured still or moving images. Examples of the cameras include cameras and video cameras having image sensors, such as charge coupled device (CCD) or complementary metal oxide semiconductor (CMOS) image sensors.

The storage unit 352 serves as the storage 32 of the information processing device 3 illustrated in FIG. 1. The storage unit 352 may include a hard disk drive (HDD) or a solid state drive (SSD), for example. The connection unit 353 is used for transmission of the results of inspection to an external device, such as display for presenting information to the user or server. The connection unit 353 may include a connection terminal of the display or a device pursuant to any of various communication protocols, such as USB, wired or wireless local area network (LAN), Bluetooth (registered trademark), or Wi-Fi.

The memory 354 is used for loading of various programs stored in the storage unit 352. The memory 354 may include a memory element or a non-transitory recording medium, such as volatile or non-volatile semiconductor memory, examples of which include random access memory (RAM) and flash memory. The processor 355 loads any of the various programs stored in the storage unit 352 into the memory 354 and executes the program. The processor 355 may include a processing unit, such as central processing unit (CPU) or micro-processing unit (MPU).

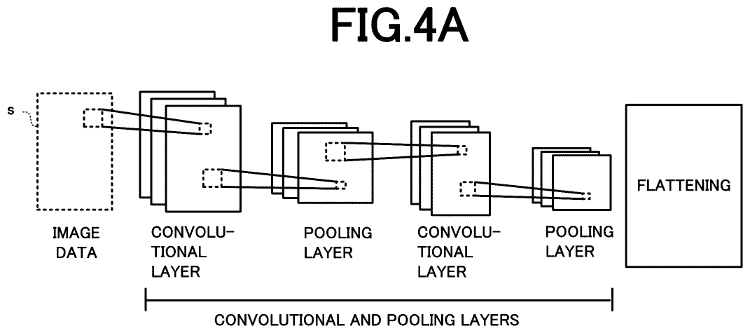

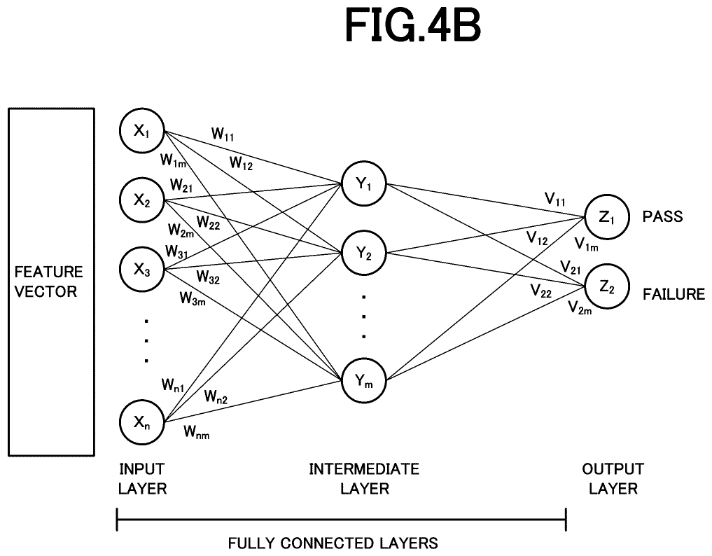

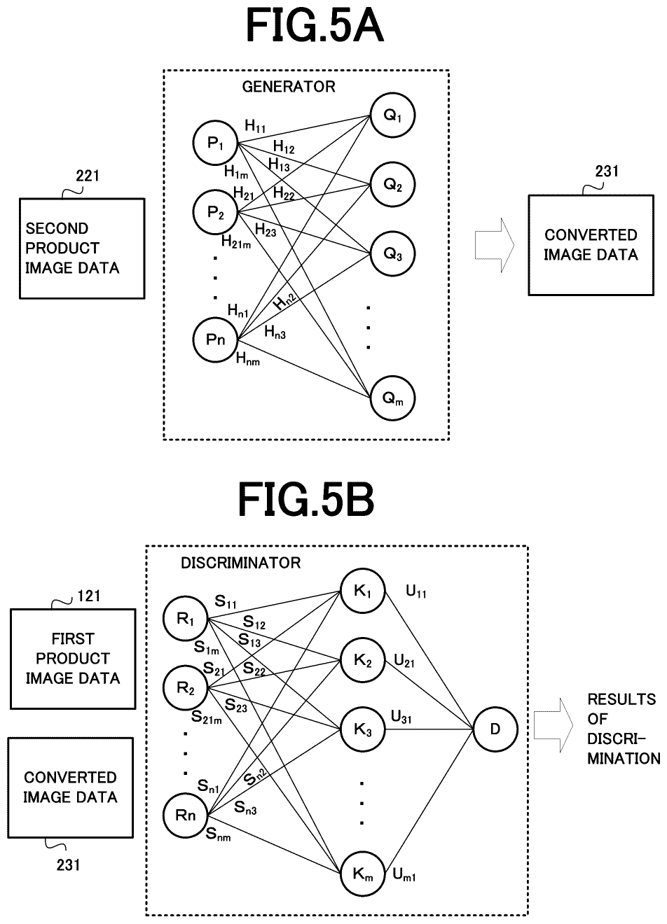

The following describes the inspection neural network 401 and the conversion neural network 402 in Embodiment 1, with reference to FIGS. 4A to 5B. FIGS. 4A and 4B are diagrams for describing the inspection neural network 401. Embodiment 1 assumes that the inspection neural network 401 is made of a convolutional neural network capable of processing a piece of image data S. The convolutional neural network is hereinafter abbreviated as “CNN”.

The CNN includes convolutional layers for convolution of features of an input piece of image data S and pooling layers for reduction of the resolution of the convoluted image, which are illustrated in FIG. 4A, and fully connected layers for classification of the convoluted image and an output layer for output of results, which are illustrated in FIG. 4B. Each of the convolutional layers compares each of all the pixels of the input image with the values in a kernel, calculates feature quantities, and generates a feature map. A monochrome image requires a single kernel, whereas a color image requires a number of kernels equal to the number of colors. For example, an RGB image having three colors requires three kernels, which are used for convolution of the input image.

The feature map generated by the convolutional layer is then input into the following pooling layer. The pooling layer executes a pooling process on the input feature map to reduce the resolution of the image. Examples of the pooling process include an average pooling process and a max pooling process. The description assumes an exemplary case of the max pooling process. For example, a procedure for compressing the 4×4 feature map into a 2×2 feature map involves extracting the pixel having the largest value from the pixels in the 2×2 region at the upper left of the feature map, and then extracting the pixel having the largest value from the pixels in each of the 2×2 regions at the lower left, upper right, and lower right of the feature map. This procedure can compress the 4×4 feature map into a 2×2 feature map.

The convolutional layers and the pooling layers are alternately arranged, as illustrated in FIG. 4A. After the pooling process by the last pooling layer, the feature quantities of the resulting piece of image data S are input into the fully connected layers. The feature quantities of the piece of image data S are input in the form of being flattened into a one-dimensional column vector. The description assumes an example in which the feature quantities extracted from the image after the pooling by the last pooling layer corresponds to 3×3 matrix data. The values of this matrix data are aligned in a line in the order from the first to third columns in the first row, from the first to third columns in the second row, and then from the first to third columns in the third row. The data after this alignment corresponds to a one-dimensional column vector, and the individual values of the column vector can then be input into the input layer of the fully connected layers. The one-dimensional column vector generated by flattening is hereinafter referred to as “feature vector”.

The fully connected layers and the output layer illustrated in FIG. 4B are made of multiple neurons. The fully connected layers include an input layer and an intermediate layer. Embodiment 1 assumes a single intermediate layer. In an exemplary case of a three-layer neural network like that illustrated in FIG. 4B, in response to input of values into an input layer X₁ to Xₙ, the input values are multiplied by weights W₁₁ to Wₙₘ, and input into an intermediate layer Y₁ to Yₘ. The values input into the intermediate layer Y₁ to Yₘ are further multiplied by weights V₁₁ to V₂ₘ, and are output from an output layer Z₁ and Z₂. The values to be output from the output layer Z₁ and Z₂ vary depending on the values of the weights W₁₁ to Wₙₘ and V₁₁ to V₂ₘ. The description assumes that n is an integer at least 4, and m is an integer at least 3.

First, the neuron of the output layer Z₁ is associated with a label “pass” indicating that the piece of image data on the inspection target product is a piece of image data S on a normal first product 11. Then, the neuron of the output layer Z₂ is associated with a label “failure” indicating that the piece of image data on the inspection target product is a piece of image data S on an abnormal first product 11. These association steps are followed by inputting the feature vectors generated by flattening the piece of image data S illustrated in FIG. 4A into the individual neurons of the input layer X₁ to Xₙ.

The individual neurons of the input layer X₁ to Xₙ receive a feature vector generated from the piece of image data S labeled as a “pass”, among the pieces of first product image data 121 stored in the first image storage 321 of the storage 32 illustrated in FIG. 1. The weights W₁₁ to Wₙₘ and V₁₁ to V₂ₘ are then adjusted such that the neuron of the output layer Z₁ associated with the label “pass” is fired among the neurons of the output layer Z₁ and Z₂. The individual neurons of the input layer X₁ to Xₙ then receive a feature vector generated from the piece of image data S labeled as a “failure”, among the pieces of first product image data 121 stored in the first image storage 321 of the storage 32 illustrated in FIG. 1. The weights W₁₁ to Wₙₘ and V₁₁ to V₂ₘ are then adjusted such that the neuron of the output layer Z₃ associated with the label “failure” is fired among the neurons of the output layer Z₁ and Z₂.

The weights W₁₁ to Wₙₘ and V₁₁ to V₂ₘ are adjusted by a back propagation algorithm, for example. The adjustment of the weights W₁₁ to Wₙₘ and V₁₁ to V₂ₘ means the learning by the inspection neural network 401. The adjustment of the weights W₁₁ to Wₙₘ and V₁₁ to V₂ₘ is hereinafter called the learning in the inspection model generator 332 illustrated in FIG. 2. The inspection model generator 332 causes the adjusted weights W₁₁ to Wₙₘ and V₁₁ to V₂ₘ to be stored into the inspection model storage 323 in the form of the piece of inspection model data 411. The inspection processor 334 of the controller 33 illustrated in FIG. 2 applies the piece of inspection model data 411 stored in the inspection model storage 323 to the inspection neural network 401, and then inspects a piece of image data on the inspection target product.

The following describes the conversion neural network 402, with reference to FIGS. 5A and 5B. The conversion neural network 402 converts the piece of second product image data 221 on an image of the second product 21 illustrated in FIG. 1 into a piece of converted image data 231 similar to the piece of first product image data 121 on an image of the first product 11. Embodiment 1 assumes an example in which the inspection neural network 401 is made of a generative adversarial network capable of converting the input piece of image data S into another piece of image data S′. The generative adversarial network is hereinafter abbreviated as “GAN”.

The GAN includes a generator illustrated in FIG. 5A that receives the input piece of second product image data 221 and generates a piece of converted image data 231, and a discriminator illustrated in FIG. 5B that receives the input piece of converted image data 231 and the input piece of first product image data 121 and discriminate them from each other. The generator illustrated in FIG. 5A includes multiple neurons constituting an input layer and an output layer. The generator may include an intermediate layer between the input layer and the output layer. The value to be input into an input layer P₁ to Pₙ is the feature vector obtained by the convolution, pooling, and flattening processes illustrated in FIG. 4A on the piece of second product image data 221 on an image of the second product 21 illustrated in FIG. 1. In response to input of the feature vector into the input layer P₁ to Pₙ, the values input into the individual neurons of the input layer P₁ to Pₙ are multiplied by weights H₁₁ to Hₙₘ, and input into the output layer Q₁ to Qₘ.

The values of the individual neurons of the output layer Q₁ to Qₘ are aligned in sequence from Q₁ to Qₘ, thereby yielding one-dimensional vector. The resulting one-dimensional vector is subject to deconvolution and unpooling processes, which are opposite to the convolution and pooling processes, and thus produces a piece of converted image data 231.

The discriminator illustrated in FIG. 5B includes multiple neurons constituting an input layer, an intermediate layer, and an output layer. Embodiment 1 assumes that the discriminator has a single intermediate layer. In an exemplary case of a three-layer neural network like that illustrated in FIG. 5B, in response to input of values into an input layer R₁ to Rₙ, the input values are multiplied by weights S₁₁ to Sₙₘ, and input into an intermediate layer K₁ to Kₘ. The values input into the intermediate layer K₁ to Kₘ are further multiplied by weights U₁₁ to Uₘ₁, and output from the output layer D. The values to be output from the output layer D vary depending on the values of the weights S₁₁ to Sₙₘ and U₁₁ to Uₘ₁. The description assumes that n is an integer at least 3, and m is an integer at least 4.

When the piece of converted image data 231 input into the input layer is not similar to the piece of first product image data 121, the discriminator outputs a value of 0 from the output layer D. When these pieces of data are similar to each other, the discriminator outputs a value of 1 from the output layer D. The feature vectors respectively generated from the piece of converted image data 231 and the piece of first product image data 121 are input into the individual neurons of the input layer R₁ to Rₙ. The weights S₁₁ to Sₙₘ and U₁₁ to Uₘ₁ are adjusted such that the value output from the output layer D in response to input of a feature vector generated from the piece of converted image data 231 approaches a value of 1.

The weights S₁₁ to Sₙₘ and U₁₁ to Uₘ₁ are adjusted by a back propagation algorithm. The back propagation algorithm involves first calculating the difference, on the basis of the value output from the output layer D in response to input of the feature vector generated from the piece of converted image data 231 into the discriminator. The algorithm involves then inputting the calculated difference into the output layer D of the discriminator, and causing the difference to propagate in the opposite direction from the intermediate layer K₁ to Kₘ to the input layer R₁ to Rₙ. The algorithm involves then generating a new piece of converted image data 231 while fixing the values of the weights H₁₁ to Hₙₘ in the generator illustrated in FIG. 5A, and adjusting the weights S₁₁ to Sₙₘ and U₁₁ to Uₘ₁ in the discriminator, followed by repetition of these steps.

The algorithm involves then calculating the difference, on the basis of the value output from the output layer D in response to input of the feature vector generated from the piece of converted image data 231 into the discriminator, while fixing the values of the weights S₁₁ to Sₙₘ and U₁₁ to Uₘ₁ in the discriminator. The algorithm involves then inputting the calculated difference into the individual neurons of the output layer Q₁ to Qₘ of the generator illustrated in FIG. 5A, causing the difference to propagate in the opposite direction to the input layer R₁ to Rₙ, and then adjusting the weights H₁₁ to Hₙₘ.

The adjustment of the weights H₁₁ to Hₙₘ in the generator is followed by the adjustment of the weights S₁₁ to Sₙₘ and U₁₁ to Uₘ₁ in the discriminator illustrated in FIG. 5B. The adjustment of the weights H₁₁ to Hₙₘ in the generator and the adjustment of the weights S₁₁ to Sₙₘ and U₁₁ to Uₘ₁ in the discriminator are thus repeated, such that the value output from the output layer D in response to input of the feature vector generated from the piece of converted image data 231 approaches a value of 1. The adjustment of the weights H₁ to Hₙₘ in the generator and the adjustment of the weights S₁₁ to Sₙₘ and U₁₁ to Uₘ₁ in the discriminator means the learning by the conversion neural network 402. The adjustment of the weights H₁₁ to Hₙₘ in the generator and the weights S₁₁ to Sₙₘ and U₁₁ to Uₘ₁ in the discriminator are hereinafter called the learning in the conversion model generator 333.

The adjusted weights H₁₁ to Hₙₘ in the generator and the adjusted weights S₁₁ to Sₙₘ and U₁₁ to Uₘ₁ in the discriminator are stored into the conversion model storage 324 of the storage 32 illustrated in FIG. 1, in the form of the piece of conversion model data 421. In the case where the piece of image data on the inspection target product is a piece of second product image data 221, the conversion processor 335 of the controller 33 illustrated in FIG. 2 converts the piece of second product image data 221 into a piece of converted image data 231 similar to the piece of first product image data 121, using the conversion neural network 402. This process is followed by the inspection using the inspection neural network 401 established by the inspection processor 334 of the controller 33 illustrated in FIG. 2.

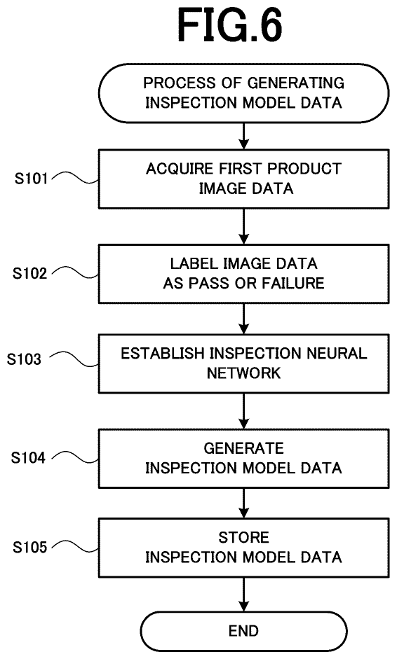

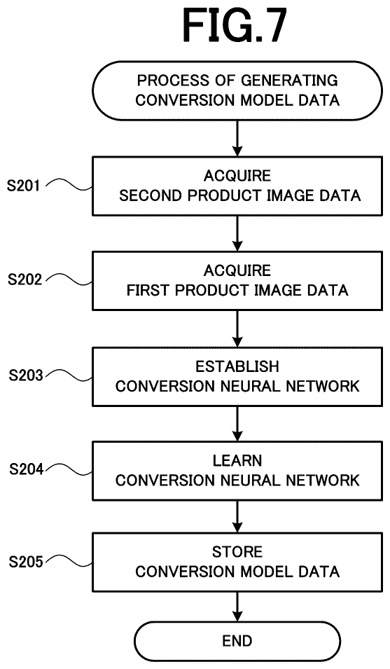

The following describes, with reference to the flowcharts illustrated in FIGS. 6 to 8, the steps of an inspection process executed by the information processing device 3 on the first product 11 of the first production line 1 and the second product 21 of the second production line 2, which are illustrated in FIG. 1. In advance of the inspection process, the information processing device 3 generates a piece of inspection model data 411 to be applied to the inspection neural network 401 and a piece of conversion model data 421 to be applied to the conversion neural network 402. The piece of inspection model data 411 and the piece of conversion model data 421 are generated as is described below, with reference to the flowchart illustrating a process of generating inspection model data in FIG. 6 and the flowchart illustrating a process of generating conversion model data in FIG. 7.

The flowchart illustrating the process of generating inspection model data in FIG. 6 is stored in the storage 32 of the information processing device 3 illustrated in FIG. 1, in the form of a program for the process of generating inspection model data. The flowchart illustrating the process of generating conversion model data in FIG. 7 is stored in the storage 32 of the information processing device 3 illustrated in FIG. 1, in the form of a program for the process of generating conversion model data. The program for the process of generating inspection model data and the program for the process of generating conversion model data are loaded from the storage unit 352 into the memory 354 and executed, by the processor 355 illustrated in FIG. 3.

The following describes operations of the program for the process of generating inspection model data, with reference to FIG. 6. The labeling processor 331 of the controller 33 illustrated in FIG. 2 acquires the pieces of first product image data 121 from the first image storage 321 of the storage 32 illustrated in FIG. 1 (Step S101). The labeling processor 331 labels the pieces of first product image data 121 as a pass or a failure (Step S102). For example, the labeling processor 331 determines a piece of first product image data 121 that satisfies the predetermined conditions to be “normal” and labels the piece of image data as a “pass”, among the clustered pieces of first product image data 121. The labeling processor 331 determines a piece of first product image data 121 that fails to satisfy the predetermined conditions to be “abnormal” and labels the piece of image data as a “failure”.

The inspection model generator 332 of the controller 33 illustrated in FIG. 2 then establishes an inspection neural network 401 (Step S103). The inspection model generator 332 causes the inspection neural network 401 to learn the pieces of first product image data 121, which are labeled as “pass” or “failure” in step 102, and generates a piece of inspection model data 411 in accordance with the results of learning (Step S104). In specific, the inspection model generator 332 yields the adjusted weights of the individual neurons in the inspection neural network 401, as the piece of inspection model data 411.

The inspection model generator 332 outputs the generated piece of inspection model data 411 to the result processor 336 of the controller 33 illustrated in FIG. 2. The result processor 336 causes the received piece of inspection model data 411 to be stored into the inspection model storage 323 of the storage 32 illustrated in FIG. 1 (Step S105). The result processor 336 then terminates the program for the process of generating inspection model data.

The following describes operations of the program for the process of generating conversion model data, with reference to the flowchart illustrated in FIG. 7. The conversion model generator 333 of the controller 33 illustrated in FIG. 2 acquires the pieces of second product image data 221 from the second image storage 322 of the storage 32 illustrated in FIG. 1 (Step S201). The conversion model generator 333 acquires the pieces of first product image data 121 from the first image storage 321 of the storage 32 illustrated in FIG. 1 (Step S202).

The conversion model generator 333 establishes a conversion neural network 402 (Step S203). The conversion model generator 333 inputs the pieces of second product image data 221 acquired in Step S201 and the pieces of first product image data 121 acquired in Step S202 into the conversion neural network 402, and causes the conversion neural network 402 to learn the input pieces of data. The conversion model generator 333 generates a piece of conversion model data 421 in accordance with the results of learning (Step S204). In specific, the conversion model generator 333 yields the adjusted weights of the individual neurons in the conversion neural network 402, as the piece of conversion model data 421.

The conversion model generator 333 outputs the generated piece of conversion model data 421 to the result processor 336 of the controller 33 illustrated in FIG. 2. The result processor 336 causes the received piece of conversion model data 421 to be stored into the conversion model storage 324 of the storage 32 illustrated in FIG. 1 (Step S205). The result processor 336 then terminates the program for the process of generating conversion model data.

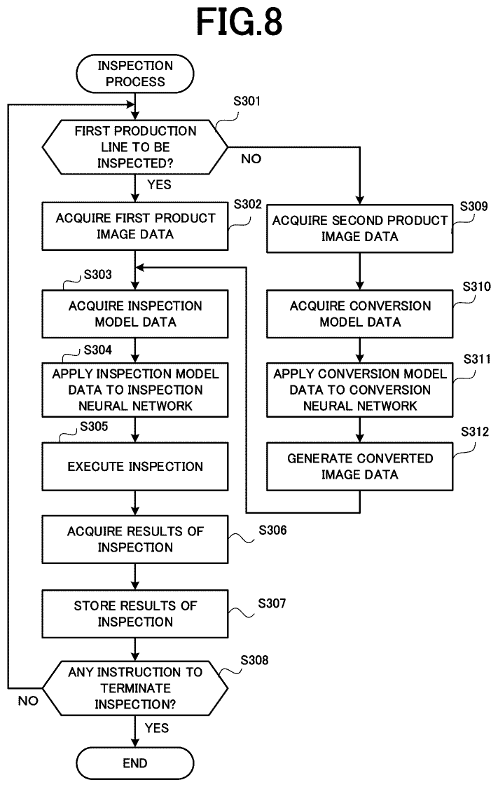

The following describes, with reference to the flowchart illustrated in FIG. 8, the steps of an inspection process executed by the information processing device 3 on the first product 11 of the first production line 1 and the second product 21 of the second production line 2, which are illustrated in FIG. 1. The flowchart illustrating the inspection process in FIG. 8 is stored in the storage 32 of the information processing device 3 illustrated in FIG. 1, in the form of the program for the inspection process. When the information processing device 3 executes the inspection process, the program for the inspection process is loaded from the storage unit 352 into the memory 354 and executed, by the processor 355 illustrated in FIG. 3.

In FIG. 8, the inspection processor 334 of the controller 33 illustrated in FIG. 2 determines whether the production line for the inspection target product is the first production line 1 (Step S301). When the production line for the inspection target product is the first production line 1 (Step S301: YES), the inspection processor 334 acquires a piece of first product image data 121 on an image of the first product 11 from the first image storage 321 of the storage 32 illustrated in FIG. 1 (Step S302).

The inspection processor 334 acquires the piece of inspection model data 411 from the inspection model storage 323 of the storage 32 illustrated in FIG. 1 (Step S303). The inspection processor 334 establishes an inspection neural network 401, and applies the piece of inspection model data 411 acquired in Step S303 to the inspection neural network 401 (Step S304).

The inspection processor 334 inputs the piece of first product image data 121 acquired in Step S302 into the inspection neural network 401, and executes inspection (Step S305). The inspection processor 334 acquires results of the inspection (Step S306). In specific, when the neuron Z₁ associated with the label “pass” indicating a normal first product 11 is fired among the neurons of the output layer illustrated in FIG. 4B, the inspection processor 334 acquires results of the inspection indicating that the first product 11 is normal. In contrast, when the neuron Z₂ associated with the label “failure” indicating an abnormal first product 11 is fired among the neurons of the output layer illustrated in FIG. 4B, the inspection processor 334 acquires results of the inspection indicating that the first product 11 is abnormal.

The inspection processor 334 outputs the results of inspection to the result processor 336 of the controller 33 illustrated in FIG. 2. The result processor 336 causes the received results of inspection to be stored into the inspection result storage 325 of the storage 32 illustrated in FIG. 1 (Step S307). The inspection processor 334 determines whether an instruction to terminate the inspection is received (Step S308). Examples of the instruction to terminate the inspection include an instruction input from the user and a termination signal input from an external device. When an instruction to terminate the inspection is received (Step S308: YES), the inspection processor 334 terminates the program for the inspection process. When no instruction to terminate the inspection is received (Step S308: NO), the inspection processor 334 returns to Step S301 and repeats Step S301 and the following steps.

When the production line to be inspected is not the first production line 1 in Step S301 (Step S301: NO), the inspection processor 334 acquires a piece of second product image data 221 on an image of the second product 21 from the second image storage 322 of the storage 32 illustrated in FIG. 1 (Step S309). The inspection processor 334 acquires the piece of conversion model data 421 from the conversion model storage 324 of the storage 32 illustrated in FIG. 1 (Step S310).

The inspection processor 334 establishes a conversion neural network 402 and applies the piece of conversion model data 421 to the conversion neural network 402 (Step S311). The inspection processor 334 inputs the piece of second product image data 221 acquired in Step S309 into the conversion neural network 402, and causes the conversion neural network 402 to generate a piece of converted image data 231 similar to the piece of first product image data 121 (Step S312).

The inspection processor 334 executes Steps S303 to S307 on the generated piece of converted image data 231. The inspection processor 334 determines whether an instruction to terminate the inspection is received (Step S308). Examples of the instruction to terminate the inspection include an instruction input from the user and a termination signal input from an external device. When an instruction to terminate the inspection is received (Step S308: YES), the inspection processor 334 terminates the program for the inspection process. When no instruction to terminate the inspection is received (Step S308: NO), the inspection processor 334 returns to Step S301 and repeats Step S301 and the following steps.

As described above, the information processing device 3 according to Embodiment 1 converts the piece of second product image data 221 on an image of the second product 21 into a piece of converted image data 231 similar to the piece of first product image data 121 on an image of the first product 11 using the conversion neural network 402, and evaluates the quality of the product by inputting the piece of converted image data 231 into the inspection neural network 401 that has learned the pieces of first product image data 121. The information processing device 3 can thus inspect a piece of inspection target data even when using an inspection model generated by learning, by machine learning means, pieces of inspection target data collected in another environment. The information processing device 3 can therefore eliminate the tasks of relearning the inspection neural network 401 for collected images.

### Embodiment 2

In Embodiment 1, generated are a piece of inspection model data 411, which is results of learning by the inspection neural network 401, and a piece of conversion model data 421, which is results of learning by the conversion neural network 402. Alternatively, multiple pieces of inspection model data 411 and multiple pieces of conversion model data 421 may be generated, followed by acquisition of the optimum combination. This configuration can obtain the optimum combination of the inspection neural network 401 and the conversion neural network 402, and thus improve the accuracy of inspection.

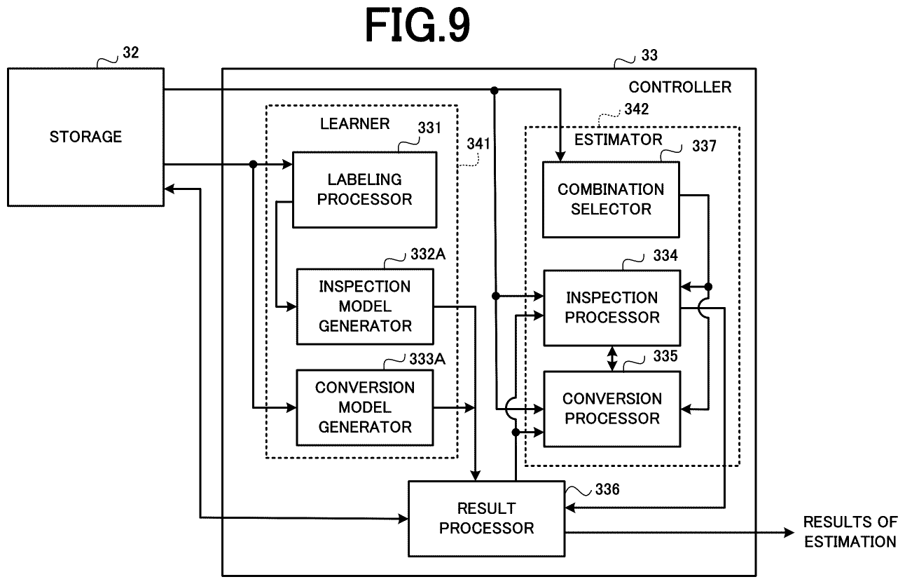

FIG. 9 illustrates a configuration of the controller 33 of the information processing device 3 according to Embodiment 2. The description focuses on the differences from Embodiment 1. The controller 33 includes an inspection model generator 332A that generates multiple pieces of inspection model data 411, a conversion model generator 333A that generates multiple pieces of conversion model data 421, and a combination selector 337 that obtains the optimum combination of a piece of inspection model data 411 and a piece of conversion model data 421. The inspection model generator 332A executes the learning by the inspection neural network 401 multiple times, and causes the individual results of the learning to be stored into the inspection model storage 323 of the storage 32 illustrated in FIG. 1, in the form of pieces of inspection model data 411A, 411B, . . . and 411n.

The conversion model generator 333A executes the learning by the conversion neural network 402 multiple times, and causes the individual results of the learning to be stored into the conversion model storage 324 of the storage 32 illustrated in FIG. 1, in the form of pieces of conversion model data 421A, 421B, . . . and 421n. The subscript n of the reference numerals is any alphabet from C to Z. The pieces of inspection model data 411A, 411B, . . . and 411n are hereinafter collectively referred to as “pieces of inspection model data 411A”. The pieces of conversion model data 421A, 421B, . . . and 421n are hereinafter collectively referred to as “pieces of conversion model data 421A”.

The combination selector 337 selects the optimum one of the combinations of a piece of inspection model data 411A selected among the pieces of inspection model data 411A and a piece of conversion model data 421A selected among the pieces of conversion model data 421A. In Embodiment 2, the piece of inspection model data 411A and the piece of conversion model data 421A selected by the combination selector 337 respectively correspond to the inspection model data 411A to be used by the inspection processor 334 of the controller 33 illustrated in FIG. 9 and the conversion model data 421A to be used by the conversion processor 335.

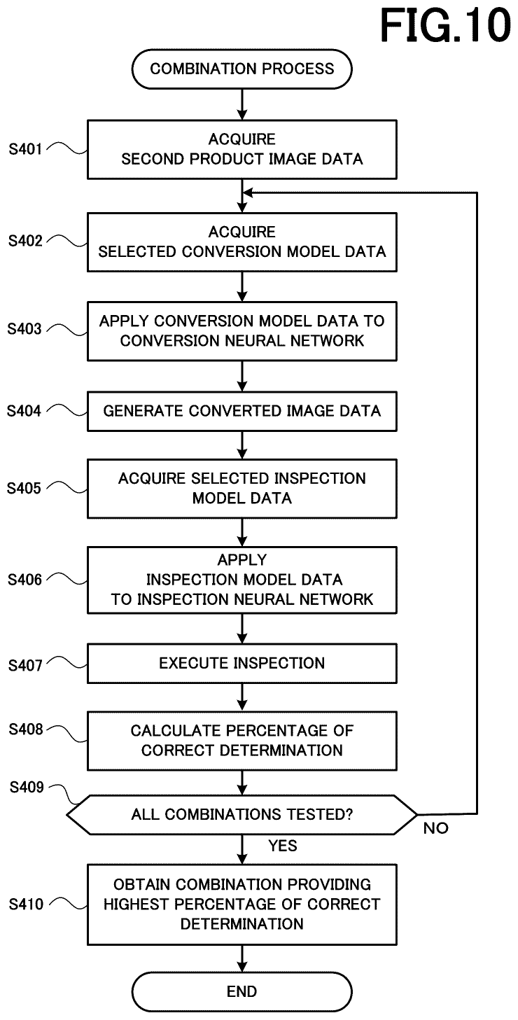

The optimum combination of the piece of inspection model data 411A and the piece of conversion model data 421A is selected by the combination selector 337, in advance of execution of the inspection process by the information processing device 3. The combination selector 337 executes a combination process, which is described below with reference to the flowchart illustrating a combination process in FIG. 10.

The flowchart illustrating the combination process in FIG. 10 is stored in the storage 32 of the information processing device 3 illustrated in FIG. 1, in the form of a program for the combination process. The program for the combination process is loaded from the storage unit 352 into the memory 354 and executed, by the processor 355 illustrated in FIG. 3.

As illustrated in FIG. 10, the combination selector 337 acquires a piece of second product image data 221 on an image of the second product 21 from the second image storage 322 of the storage 32 illustrated in FIG. 1 (Step S401). The combination selector 337 also acquires a piece of conversion model data 421A selected among the pieces of conversion model data 421A, 421B, . . . and 421n stored in the conversion model storage 324 of the storage 32 illustrated in FIG. 1 (Step S402).

The combination selector 337 establishes a conversion neural network 402, and applies the piece of conversion model data 421A acquired in Step S402 to the conversion neural network 402 (Step S403). The combination selector 337 inputs the piece of second product image data 221 acquired in Step 401 into the conversion neural network 402, and generates a piece of converted image data 231 illustrated in FIG. 5A (Step S404).

The combination selector 337 acquires a piece of inspection model data 411A selected among the pieces of inspection model data 411A, 411B, . . . and 411n stored in the inspection model storage 323 of the storage 32 illustrated in FIG. 1 (Step S405). The combination selector 337 establishes an inspection neural network 401, and applies the piece of inspection model data 411A acquired in Step 405 to the inspection neural network 401 (Step S406).

The combination selector 337 inputs the piece of converted image data 231 generated in Step S404 into the inspection neural network 401, and executes inspection (Step S407). The combination selector 337 calculates a percentage of correct determination from results of the inspection (Step S408). The combination selector 337 determines whether the combination selector 337 has tested all the combinations of the pieces of inspection model data 411A and the pieces of conversion model data 421A (Step S409).

When determining that the combination selector 337 has tested all the combinations of the pieces of inspection model data 411A and the pieces of conversion model data 421A (Step S409; YES), the combination selector 337 obtains the combination that provides the highest percentage of correct determination (Step S410). The combination selector 337 then terminates the program for the combination process. When determining that the combination selector 337 has not tested all the combinations of the pieces of inspection model data 411A and the pieces of conversion model data 421A (Step S409; NO), the combination selector 337 returns to Step S402 and repeats Steps S402 to S409.

As described above, the configuration according to Embodiment 2 can obtain the optimum one of the combinations of the pieces of inspection model data 411A and the pieces of conversion model data 421A, in addition to the effects of Embodiment 1. The configuration can thus obtain the optimum combination of the inspection neural network 401 and the conversion neural network 402, and thus improve the accuracy of inspection.

### Modification 1

Although the images of inspection target products correspond to the pieces of first product image data 121 stored in the first image storage 321 of the storage 32 and the pieces of second product image data 221 stored in the second image storage 322 of the storage 32 in Embodiments 1 and 2 described above, this configuration is a mere example. The image data on inspection target products may also be pieces of image data acquired directly from the first imager 12 that captures images of the first products 11 and the second imager 22 that captures images of the second products 21, which are illustrated in FIG. 1. Alternatively, the image data on inspection target products may be pieces of image data on images captured in an external production line.

### Modification 2

The information processing device 3 in Embodiments 1 and 2 described above may be provided with a display, which can present results of inspection to the user in real time.

### Modification 3

Although the piece of inspection model data 411 to be applied to the inspection neural network 401 is generated by learning the pieces of first product image data 121 labeled as a pass or a failure, which are so-called supervised data, in Embodiments 1 and 2 described above, this configuration is a mere example. The piece of inspection model data 411 may also be generated by learning pieces of first product image data 121 not labeled as a pass or a failure, which are so-called unsupervised data.

### Modification 4

Although the inspection neural network 401 is made of a CNN in Embodiments 1 and 2 described above, this configuration is a mere example. Any machine learning means may also be applied provided that the means is capable of learning pieces of first product image data 121 and evaluating the quality of an inspection target product from the piece of first product image data 121 and the piece of second product image data 221. Instead of the conversion neural network 402 made of a GAN, any machine learning means may be applied provided that the means is capable of converting the piece of second product image data 221 into the piece of converted image data 231 similar to the piece of first product image data 121.

### Modification 5

Although the data to be learned and inspected by the inspection neural network 401 is the pieces of first product image data 121 on images of the first products 11 and the pieces of converted image data 231 generated by converting the pieces of second product image data 221 on images of the second products 21 in Embodiments 1 and 2 described above, this configuration is a mere example. The data to be learned and inspected by the inspection neural network 401 may also be pieces of data on the first products 11 and the second products 21 other than image data. Alternatively, the data to be learned and inspected by the inspection neural network 401 may be pieces of inspection target data based on inspection target products other than the first products 11 and the second products 21.

### Modification 6

Although the controller 33 of the information processing device 3 includes both of the learner 341 and the estimator 342 as illustrated in FIGS. 2 and 9, in Embodiments 1 and 2 described above, this configuration is a mere example. The controller 33 of the information processing device 3 may include the estimator 342 alone. In this case, the learner 341 is replaced with a learning device 341A disposed outside the information processing device 3. The learning device 341A generates at least one piece of inspection model data 411 and at least one piece of conversion model data 421, which are results of learning. The generated piece of inspection model data 411 and piece of conversion model data 421 may be acquired by the inspection processor 334 and the conversion processor 335 of the estimator 342 at any timing, and applied to the inspection neural network 401 and the conversion neural network 402, respectively. The learning device 341A and the information processing device 3 may constitute an information processing system.

The labeling processor 331, the inspection model generator 332, and the conversion model generator 333, which are included in the learner 341, may each be an independent device. These devices and the information processing device 3 may constitute an information processing system.

### Modification 7

In Embodiment 2 described above, the combination of a piece of inspection model data 411A and a piece of conversion model data 421A that provides the highest percentage of correct determination is obtained among the percentages of correct determination calculated in accordance with the results of inspection of the pieces of first product image data 121 and the pieces of second product image data 221. The combination of a piece of inspection model data 411A and a piece of conversion model data 421A may also be obtained by another procedure.

The following description assumes an example in which a piece of product image data acquired in any production line is inspected using an inspection neural network 401a set by applying a piece of inspection model data 411a thereto and a conversion neural network 402b set by applying a piece of conversion model data 421b thereto. Configuration (1) is defined in which a piece of converted image data generated by converting the piece of product image data using the conversion neural network 402b is inspected using the inspection neural network 401a. Configuration (2) is defined in which the piece of product image data is directly inspected using the inspection neural network 401a. The percentage of correct determination calculated from the results of inspection in Configuration (1) is assumed to be α%, and the percentage of correct determination calculated from the results of inspection in Configuration (2) is assumed to be β%.

When the percentages of correct determination in Configurations (1) and (2) satisfy the inequation α>β, the combination of the piece of inspection model data 411a and the piece of conversion model data 421b in Configuration (1) is determined to be the optimum combination. When the percentages of correct determination in Configurations (1) and (2) satisfy the inequation α<β, the combination of the piece of inspection model data 411a and the piece of conversion model data 421b is determined to be inappropriate.

The percentages of correct determination in Configurations (1) and (2) that satisfy the inequation α<β seem to be caused by a low accuracy of the piece of conversion model data 421b. The piece of conversion model data 421b is thus revised into a new piece of conversion model data 421c through the relearning by the conversion neural network 402b. Configuration (3) is defined in which a piece of converted image data generated by converting the piece of product image data using a conversion neural network 402c set by applying the piece of conversion model data 421c thereto is inspected using the inspection neural network 401a set by applying the piece of inspection model data 411a thereto. The percentage of correct determination calculated from the results of inspection in Configuration (3) is assumed to be γ%.

When the percentages of correct determination in Configurations (2) and (3) satisfy the inequation β<γ, the piece of conversion model data 421c is determined to have a higher accuracy than the piece of conversion model data 421b. When the percentages of correct determination in Configurations (1) and (3) satisfy the inequation α>γ, the combination of the piece of inspection model data 411a and the piece of conversion model data 421c is determined to be the optimum combination.

The information processing device 3 can be achieved by a dedicated system in Embodiments 1 and 2 of the present disclosure. Alternatively, the information processing device 3 may be achieved by an ordinary computer system without a dedicated system. For example, a program for performing the above-described functions of the information processing device 3 may be stored in a non-transitory computer-readable recording medium, such as compact disc read only memory (CD-ROM) or digital versatile disc read only memory (DVD-ROM), and distributed. This program when installed in a computer may cause the computer to perform the above-described functions. In the case where the functions are achieved by sharing of an operating system (OS) and an application or by cooperation of the OS and the application, only the application may be stored in a non-transitory recording medium.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be appropriately applied to an information processing device.

### REFERENCE SIGNS LIST

1 First production line
2 Second production line
3 Information processing device
11, 11A-11N First product
12 First imager
21, 21A-21N Second product
22 Second imager
31 Image acquirer
32 Storage
33 Controller
100 Information processing system
121 First product image data
221 Second product image data
231 Converted image data
321 First image storage
322 Second image storage
323 Inspection model storage
324 Conversion model storage
325 Inspection result storage
331 Labeling processor
332, 332A Inspection model generator
333, 333A Conversion model generator
334 Inspection processor
335 Conversion processor
336 Result processor
337 Combination selector
341 Learner
341A Learning device
342 Estimator
351 Input/output port
352 Storage unit
353 Connection unit
354 Memory
355 Processor
356 Data bus
401, 401a Inspection neural network
402, 402b, 402c Conversion neural network
411, 411A-411N, 411a Inspection model data
421, 421A-421N, 421b, 421c Conversion model data

1. An information processing device, comprising:
a processor to execute a program; and
a memory to store the program which, when executed by the processor, performs processes of,
inspecting quality of an inspection target product based on inspection model data for inspection of the quality of the inspection target product, the inspection model data being generated by learning first inspection target data the first inspection target data being data based on a first product;
converting inspection target data that is data based on the inspection target product into converted inspection target data similar to the first inspection target data based on conversion model data for conversion of second inspection target data into the converted inspection target data, the conversion model data being generated by learning second inspection target data and the first inspection target data, the second inspection target data being data based on a second product, wherein
in the inspecting of the quality
when a determination is made in accordance with external information that the inspection target product is a first product, the inspection target data that is data based on the inspection target product is directly inspected, and
when a determination is made in accordance with the external information that the inspection target product is a second product, the converted inspection target data obtained by conversion by the conversion processor from the inspection target data is inspected.

2. The information processing device according to claim 1, wherein
the processor generates pieces of the inspection model data and pieces of the conversion model data, and
the processor inspects the inspection target product for each of combinations of one of the pieces of inspection model data and one of the pieces of conversion model data and selects an optimum combination among the combinations based on results of the inspection.

3. An information processing system, comprising:
the information processing device according to claim 1; and
a learning device including a second processor to execute a second program, and a second memory to store the second program which, when executed by the second processor, performs processes of,
generating the inspection model data based on a result of the learning by the inspection learning means for learning the first inspection target data, and
generating the conversion model data based on a result of the learning of the first inspection target data and the second inspection target data.

4.-6. (canceled)

7. An information processing system, comprising:
the information processing device according to claim 2; and
a learning device including a second processor to execute a second program, and a second memory to store the second program which, when executed by the second processor, performs processes of,
generating the inspection model data based on a result of the learning by the inspection learning means for learning the first inspection target data, and
generating the conversion model data based on a result of the learning of the first inspection target data and the second inspection target data.

8. The information processing system according to claim 3, wherein
the second processor of the learning device labels, as a pass, a piece of first inspection target data determined to be normal based on a predetermined condition among pieces of the first inspection target data, and
the second processor of the learning device labels, as a failure, a piece of first inspection target data determined to be abnormal based on a predetermined condition among the pieces of first inspection target data, and
the second processor of the learning device learns the pieces of first inspection target data labeled as the pass or the failure.

9. The information processing system according to claim 7, wherein
the second processor of the learning device labels, as a pass, a piece of first inspection target data determined to be normal based on a predetermined condition among pieces of the first inspection target data, and
the second processor of the learning device labels, as a failure, a piece of first inspection target data determined to be abnormal based on a predetermined condition among the pieces of first inspection target data, and
the second processor of the learning device learns the pieces of first inspection target data labeled as the pass or the failure.

10. An information processing method, the method comprising:
inspecting quality of an inspection target product based on inspection model data for inspection of the quality of the inspection target product, the inspection model data being generated by learning pieces of first inspection target data, the first inspection target data being data based on a first product; and
converting inspection target data that is data based on the inspection target product into conversion inspection target data similar to the first inspection target data based on conversion model data for conversion of second inspection target data into the converted inspection target data, the conversion model data being generated by learning second inspection target data and the first inspection target data, the second inspection target data being data based on a second product, wherein
in the inspecting of the quality,
when a determination is made in accordance with external information that the inspection target product is a first product, the inspection target data that is data based on the inspection target product is directly inspected, and
when a determination is made in accordance with the external information that the inspection target product is a second product, the converted inspection target data obtained by conversion from the inspection target data is inspected.

11. A non-transitory computer-readable recording medium storing a program, the program causing a computer to execute processing comprising:
inspecting quality of an inspection target product based on inspection model data for inspection of the quality of the inspection target product, the inspection model data being generated by learning first inspection target data, the first inspection target data being data based on a first product; and
converting inspection target data that is data based on the inspection target product into conversion inspection target data similar to the first inspection target data based on conversion model data for conversion of second inspection target data into the converted inspection target data, the conversion model data being generated by learning second inspection target data and the first inspection target data, the second inspection target data being data based on a second product, wherein
in the inspecting of the quality,
when a determination is made in accordance with external information that the inspection target product is a first product, the inspection target data that is data based on the inspection target product is directly inspected, and
when a determination is made in accordance with the external information that the inspection target product is a second product, the converted inspection target data obtained by conversion from the inspection target data is inspected.
